(19) United States
(12) Patent Application Publication
(10) Pub. No.: US 2025/0088325 A1
(43) Pub. Date: Mar. 13, 2025

(54) CONFIGURATION OF SIDELINK REFERENCE SIGNALS

(71) Applicant: Nokia Technologies OY, Espoo (FI)

(72) Inventors: Oana-Elena BARBU, Aalborg (DK); Nuno Manuel KILERICH PRATAS, Aalborg (DK); Benny VEJLGAARD, Aalborg (DK); Johannes HARREBEK, Aalborg (DK); Jan Torst HVIID, Aalborg (DK); Prajwal KESHAVAMURTHY, Munich (DE)

(21) Appl. No.: 18/721,843

(22) PCT Filed: Dec. 13, 2022
(86) PCT No.: PCT/EP2022/085550

§ 371 Date: Jun. 19, 2024

Related U.S. Application Data
(60) Provisional application No. 63/299,494, filed on Jan. 14, 2022.

(51) Int. Cl. H04L 5/00; H04W 72/40

(52) U.S. Cl. CPC H04L 5/005; H04W 72/40

(57) ABSTRACT

There is provided an apparatus which is a first apparatus comprising one or more processors, and one or more memories storing instructions that, when executed by the one or more processors, cause the first apparatus at least to perform: detecting at least one join request broadcasted by at least one second apparatus, wherein the at least one join request is indicative of a request to join a sidelink reference signal exchange session; transmitting a response to the at least one second apparatus, wherein the response is indicative at least of an identity of the first apparatus; receiving, from at least one second apparatus, a first configuration set comprising an identity of at least one first apparatus paired with a sidelink reference signal configuration; receiving at least one further message indicative of one or more sidelink reference signal configurations; and based at least on the first configuration set and the at least one further message, selecting at least one non-conflicting sidelink reference signal configuration for the sidelink reference signal exchange session with the at least one second apparatus.

### FIELD

Various example embodiments relate to configuration of sidelink reference signals.

### BACKGROUND

Sidelink communication refers to direct communication between user devices or user equipments without communicating via network node or base station. Sidelink communications are often used for critical public safety and law enforcement by police, army, first responders, etc., and for vehicular communication (V2X), for example.

### SUMMARY

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

### BRIEF DESCRIPTION OF THE DRAWINGS

FIG. 1 shows, by way of example, a network architecture of communication system;

FIG. 2a shows, by way of example, sidelink resource allocation in mode 1;

FIG. 2b shows, by way of example, sidelink resource allocation in mode 2;

FIG. 3 shows, by way of example, sidelink positioning and/or ranging scenario;

FIG. 4 shows, by way of example, a flow chart of a method;

FIG. 5 shows, by way of example, a flow chart of a method;

FIG. 6 shows, by way of example, signalling between user equipments; and

FIG. 7 shows, by way of example, a block diagram of an apparatus.

### DETAILED DESCRIPTION

In sidelink reference signal exchange sessions, conflicting resources may be configured for user equipments. For example, in sidelink positioning, conflicting resources may be configured by target user equipments for transmission of the sidelink positioning reference signals by anchor equipments. A reactive conflict resolution procedure is provided, wherein the anchor equipments receive information on reserved configurations from the target equipments and other anchor equipments to allow the anchor equipments to reconfigure the positioning session by excluding conflicting resources.

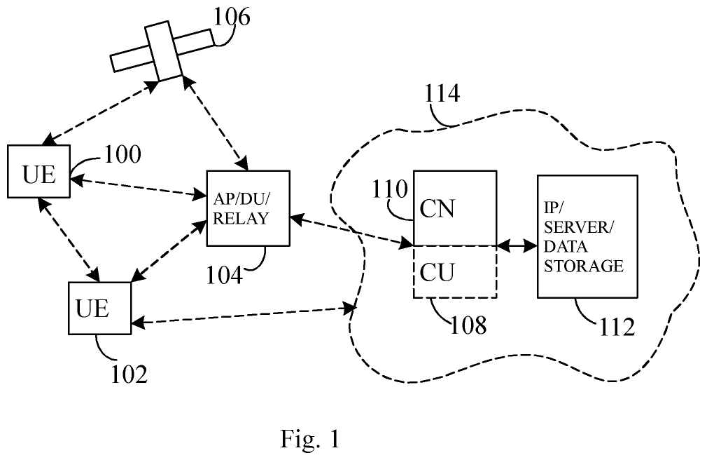

FIG. 1 shows, by way of an example, a network architecture of communication system. In the following, different exemplifying embodiments will be described using, as an example of an access architecture to which the embodiments may be applied, a radio access architecture based on long term evolution advanced (LTE Advanced, LTE-A) or new radio (NR), also known as fifth generation (5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The example of FIG. 1 shows a part of an exemplifying radio access network. FIG. 1 shows user devices 100 and 102 configured to be in a wireless connection on one or more communication channels in a cell with an access node, such as gNB, i.e. next generation NodeB, or eNB, i.e. evolved NodeB (eNodeB), 104 providing the cell. The physical link from a user device to the network node is called uplink (UL) or reverse link and the physical link from the network node to the user device is called downlink (DL) or forward link. It should be appreciated that network nodes or their functionalities may be implemented by using any node, host, server or access point etc. entity suitable for such a usage. A communications system typically comprises more than one network node in which case the network nodes may also be configured to communicate with one another over links, wired or wireless, designed for the purpose. These links may be used for signalling purposes. The network node is a computing device configured to control the radio resources of the communication system it is coupled to. The network node may also be referred to as a base station (BS), an access point or any other type of interfacing device including a relay station capable of operating in a wireless environment. The network node includes or is coupled to transceivers. From the transceivers of the network node, a connection is provided to an antenna unit that establishes bi-directional radio links to user devices. The antenna unit may comprise a plurality of antennas or antenna elements. The network node is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. An example of the network node configured to operate as a relay station is integrated access and backhaul node (IAB). The distributed unit (DU) part of the JAB node performs BS functionalities of the JAB node, while the backhaul connection is carried out by the mobile termination (MT) part of the JAB node. UE functionalities may be carried out by JAB MT, and BS functionalities may be carried out by JAB DU. Network architecture may comprise a parent node, i.e. IAB donor, which may have wired connection with the CN, and wireless connection with the JAB MT.

The user device, or user equipment UE, typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. A user device may also be a device having capability to operate in Internet of Things (IoT) network which is a scenario in which objects are provided with the ability to transfer data over a network without requiring human-to-human or human-to-computer interaction.

Additionally, although the apparatuses have been depicted as single entities, different units, processors and/or memory units (not all shown in FIG. 1) may be implemented inside these apparatuses, to enable the functioning thereof.

5G enables using multiple input-multiple output (MIMO) technology at both UE and gNB side, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 7 GHz, cmWave and mmWave, and also being integratable with existing legacy radio access technologies, such as the LTE. Below 7 GHz frequency range may be called as FR1, and above 24 GHz (or more exactly 24-52.6 GHz) as FR2, respectively. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 7 GHz-cmWave, below 7 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side (in a distributed unit, DU 104) and non-real time functions being carried out in a centralized manner (in a centralized unit, CU 108).

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 106 in the constellation may cover several satellite-enabled network entities that create on-ground cells. The on-ground cells may be created through an on-ground relay node 104 or by a gNB located on-ground or in a satellite.

Sidelink communication refers to direct communication between user devices or user equipments without communicating via network node or base station. For example, UEs 100, 102 of FIG. 1 may communicate with each other via sidelink resources. Sidelink communications are often used for vehicular communication, critical public safety and law enforcement by police, army, first responders, etc.

Resource allocation in sidelink transmissions are considered to follow two modes, that is, mode 1 and mode 2. In mode 1, sidelink resources are scheduled by a network node, e.g. a gNB. In mode 2, the user equipment autonomously selects sidelink resources from a configured or pre-configured sidelink resource pool(s) based on a channel sensing mechanism. If the UE is in coverage area of a network node, the network may be configured to adopt mode 1 or mode 2 communication mechanism. If the UE is out of the coverage area of the network node, the mode 2 is adopted as the communication mechanism.

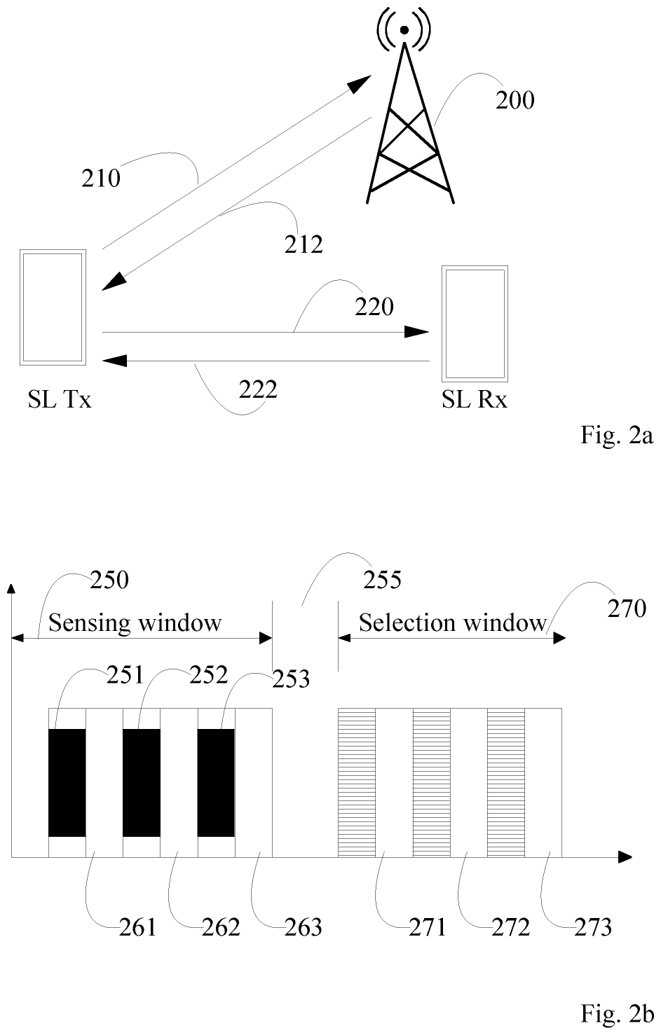

FIG. 2a shows, by way of example, sidelink resource allocation in mode 1. Transmitting UE (SL Tx) sends 210 a sidelink scheduling request (SL-SR) to a network node 200, which assigns 212 the sidelink transmission resource to the SL Tx UE. The Tx UE transmits 220 to the receiving UE (SL Rx) using the assigned sidelink resources on the physical sidelink control channel (PSCCH) and/or the physical sidelink shared channel (PSSCH). The SL Tx UE receives 222 feedback from the SL Rx UE on the physical sidelink feedback channel (PSFCH). The configuration and operation for the resource allocation in the mode 1 is similar to the one over the Uu interface.

FIG. 2b shows, by way of example, sidelink resource allocation in mode 2. In mode 2, the transmitting UE selects autonomously the resources for the physical sidelink control channel (PSCCH) and/or the physical sidelink shared channel (PSSCH). First, the transmitting UE performs a sensing procedure during the sensing window 250 to obtain knowledge of the reserved resources 251, 252, 253, i.e. resources reserved by other nearby transmitting UEs. Based on the knowledge obtained from sensing, the SL Tx UE may select resources from the available SL resources, accordingly. For example, FIG. 2b shows the resources deemed as available 261, 262, 263 for selection for the next period. Resource selection decision is made during a time period 255 (sub-frame n) in between the sensing window 250 and the selection window 270. Listen-before-talk check may be performed prior to access the resources deemed as available 271, 272, 273 for selection.

To perform sensing and obtain the necessary information to receive a SL transmission, the UE decodes the sidelink control information (SCI). The SCI may comprise a plurality of fields. It may be enough for the transmitting UE to know which resources are occupied by other UEs. The UE might not need to transmit all the fields of SCI in a single stage. The fields of SCI may be transmitted in two stages, a first stage SCI and a second stage SCI. The first stage SCI may be transmitted by the PSCCH, and the first stage SCI carries information regarding the PSSCH resources and information for decoding the second stage SCI. The second stage SCI may be multiplexed with the PSSCH, and the second stage SCI carries the remaining scheduling information for the PSSCH decoding by the target UE.

Reference signals may be exchanged between the UEs via sidelink resources. Reference signal exchange may be applied in positioning, to facilitate beam alignment and sharing of channel state information, for example.

Following positioning solutions have been specified for New Radio Release 16: Downlink Time Difference of Arrival (DL-TDOA), Uplink Time Difference of Arrival (UL-TDOA), Downlink Angle of Departure (DL-AoD), Uplink Angle of Arrival (UL-AoA), Multi-cell Round Trip Time (Multi-RTT). A positioning reference signal (PRS) has been introduced for the DL techniques and a sounding reference signal for positioning (SRS-P) has been introduced for the UL techniques.

Ranging in wireless networks refers to the ability to determine positions of the devices in the network based on known positions of some devices and distance estimates between the devices. For example, the distance may be estimated or calculated based on time of flight, and positions may be calculated using trilateration.

Ranging may be performed between UEs via sidelink communication. Sidelink positioning may be considered to support three use cases, absolute sidelink positioning, relative sidelink positioning, and sidelink assisted positioning. Absolute and relative sidelink positioning may be used when the device is out of network coverage or the devices use sidelink only mode in coverage. Sidelink assisted positioning may be used in network coverage or in partial coverage.

Absolute sidelink positioning is based on known locations of some devices. For example, road-side units (RSUs) may be located in known locations, and on-board unit in a vehicle may communicate with these RSUs via sidelink. Absolute location of the RSUs is known, and the absolute location of the on-board unit may be calculated. Sidelink positioning reference signals (S-PRS) are communicated between the RSUs and the on-board unit.

In relative sidelink positioning, the distance and angle of arrival are calculated by the target device. Relative location of the on-board units may be calculated based on the S-PRS communicated between the on-board units.

In sidelink assisted positioning, the position calculation is network-based. That is, the position is calculated by location services (LCS). Absolute location of the on-board unit may be calculated based on the RSUs in known locations. S-PRSs are exchanged between the RSUs and the on-board unit, and the measurements are transmitted to the network for position calculation.

Sidelink transmissions are organized in frames identified by a direct frame number (DFN). The DFN enables a UE to synchronize its radio frame transmissions according to the sidelink timing reference. UEs perform sidelink synchronization to have the same sidelink timing reference for sidelink communication among nearby UEs by synchronizing with a reference. There are four sources for synchronization reference: Global navigation satellite system (GNSS), NR Cell (gNB), EUTRAN Cell (eNB), SyncRef UE or UE's own internal clock. Here, SyncRef UE is a UE acting as a synchronization reference source that either extends the synchronization coverage of a synchronization source (e.g., GNSS, gNB/eNB or another SyncRef UE) or uses its own internal clock as the synchronization reference.

In general, NR positioning session is configured and triggered by a location management function (LMF) which collects information from several transmit receive points (TRP) regarding their availability to participate in helping the positioning of a given UE, i.e. a target UE. The LMF acts as a coordinator, i.e. a central network entity, which selects and configures the transmission of positioning reference signals (PRS) by several TRPs so that the signals do not interfere with each other and they are easily distinguishable by the given UE. The configuration of PRS comprises selecting the time-frequency-code resources, and optionally space resources, to be used by the available TRPs to enable the localization of the given UE within precise latency and accuracy requirements.

In out-of-coverage (OOC) sidelink positioning and/or ranging, the LMF becomes unavailable. Thus, the sidelink devices aim to find alternative ways to configure, trigger and successfully finalize the positioning and/or ranging session.

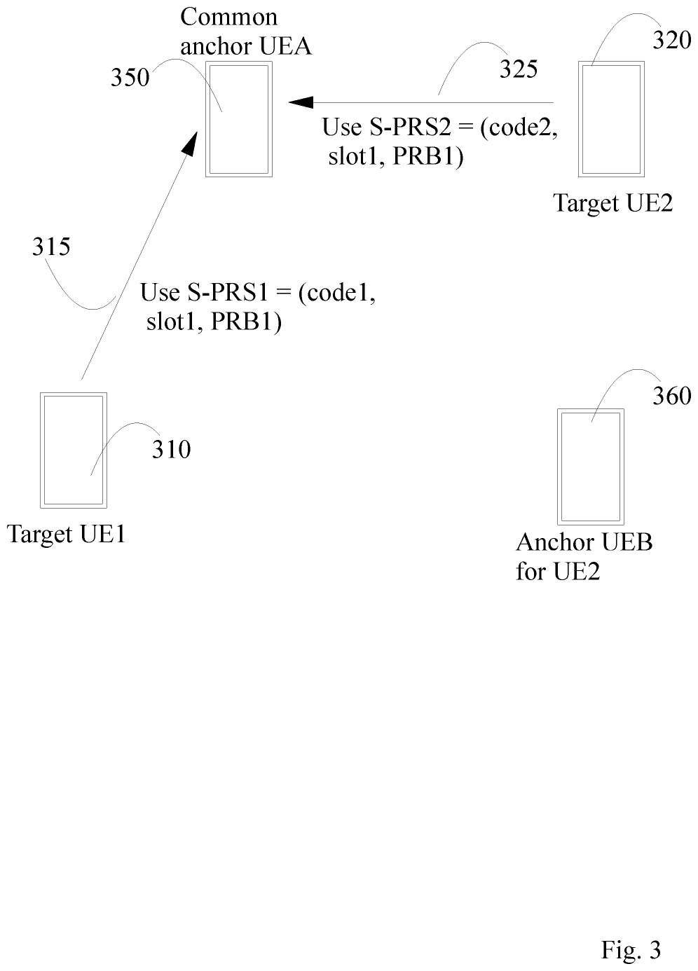

FIG. 3 shows, by way of example, sidelink positioning and/or ranging scenario. For example, the target UE 310, 320, i.e. the UE in need of positioning and/or ranging assistance, may be enabled to discover and configure other sidelink UEs, i.e. anchor UEs 350, 360, to transmit sidelink positioning reference signals (S-PRSs) according to a preferred configuration. In other words, the target UE 310, 320 selects S-PRS configuration for the anchor UE and transmits the configuration to the anchor UE. This configuration may include details such as the S-PRS generation details and the resources to be used for the S-PRS transmission. For example, in case of Zadoff-Chu sequence, the S-PRS generation details may comprise the generating root sequence and cyclic shift applied, and the length of the sequence which may be determined based on the accuracy requirements. The resources to be used for the S-PRS transmission may be defined by e.g. a slot, a symbol and/or frequency, and a sub-channel.

For example, a first target UE, UE1 310 configures 315 the anchor UEA 350 to use S-PRS1 with configuration parameters “code 1, slot1, physical resource block 1 (PRB1)”. A second target UE 320 configures 325 the same anchor UEA 350 to use S-PRS2 with configuration parameters “code2, slot1, PRB1”. The anchor UEA 350 is a common anchor for the first target UE 350 and the second target UE 320.

Thus, several target UEs 310, 320 may choose the same anchor UE 350 and select conflicting S-PRS configuration for the same anchor UE. Different target UEs 310, 320 are unaware of each other.

In the example of FIG. 3, a common anchor UEA 350 experiences a S-PRS conflict between the S-PRS1 and S-PRS2. That is, the slot1 and PRB1 have been selected for usage with two different codes, i.e. code1 and code2. The anchor UE may resolve the conflict by deciding to use one of the two signals, e.g. transmit S-PRS1 to serve both target UEs, i.e. UE1 and UE2, simultaneously and inform UE2 about the configuration change. While SL-PRS1 may be preferred by the UE1 310, it may be suboptimal for the channel conditions towards the UE2 320. Thus, the conflict may lead to S-PRS configurations (e.g. time, frequency or code parameters) that are incompatible for some target UEs or not preferred by some target UEs. For example, UE2 may have different localization needs in terms of latency and accuracy than UE1.

In addition, the S-PRS1 may be chosen by another anchor UE of UE2, e.g. anchor UEB 360. Then, the UE2 320 may end up receiving the same signal from two different anchor UEs simultaneously, which makes the anchors undistinguishable.

Methods are provided for conflict resolution in sidelink reference signal exchange sessions, such as in sidelink positioning.

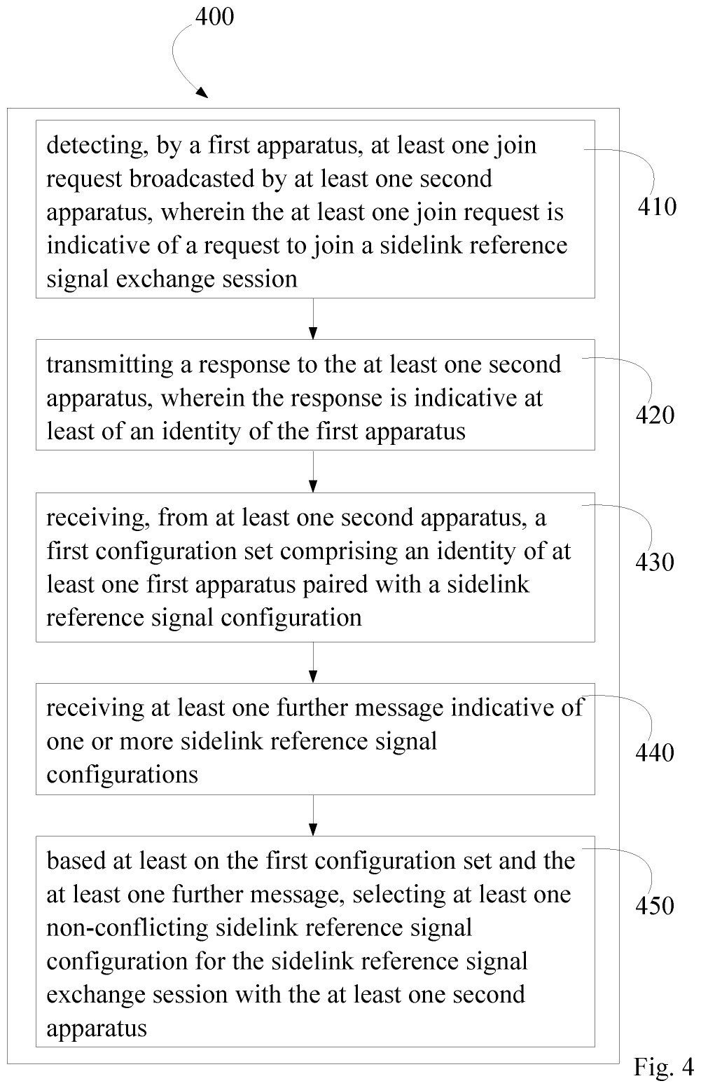

FIG. 4 shows, by way of example, a flowchart of a method 400. The method may be performed by an apparatus, e.g. a first apparatus, which may be an anchor UE. The method 400 comprises detecting 410, by a first apparatus, at least one join request broadcasted by at least one second apparatus, wherein the at least one join request is indicative of a request to join a sidelink reference signal exchange session. The method 400 comprises transmitting 420 a response to the at least one second apparatus, wherein the response is indicative at least of an identity of the first apparatus. The method 400 comprises receiving 430, from at least one second apparatus, a first configuration set comprising an identity of at least one first apparatus paired with a sidelink reference signal configuration. The method 400 comprises receiving 440 at least one further message indicative of one or more sidelink reference signal configurations. The method 400 comprises: based at least on the first configuration set and the at least one further message, selecting 450 at least one non-conflicting sidelink reference signal configuration for the sidelink reference signal exchange session with the at least one second apparatus.

The sidelink reference signal exchange session may be, for example, a sidelink positioning session, that is, a ranging session. The sidelink reference signal may be a sidelink positioning reference signal, S-PRS, for example. Other sidelink reference signals may be e.g. phase tracking reference signals (PT-RSs) for phase tracking, sounding reference signals (SRSs) for channel sounding, tracking reference signals (TRSs) for enhanced synchronization, and CSI reference signals (CSI-RSs) for beam alignment.

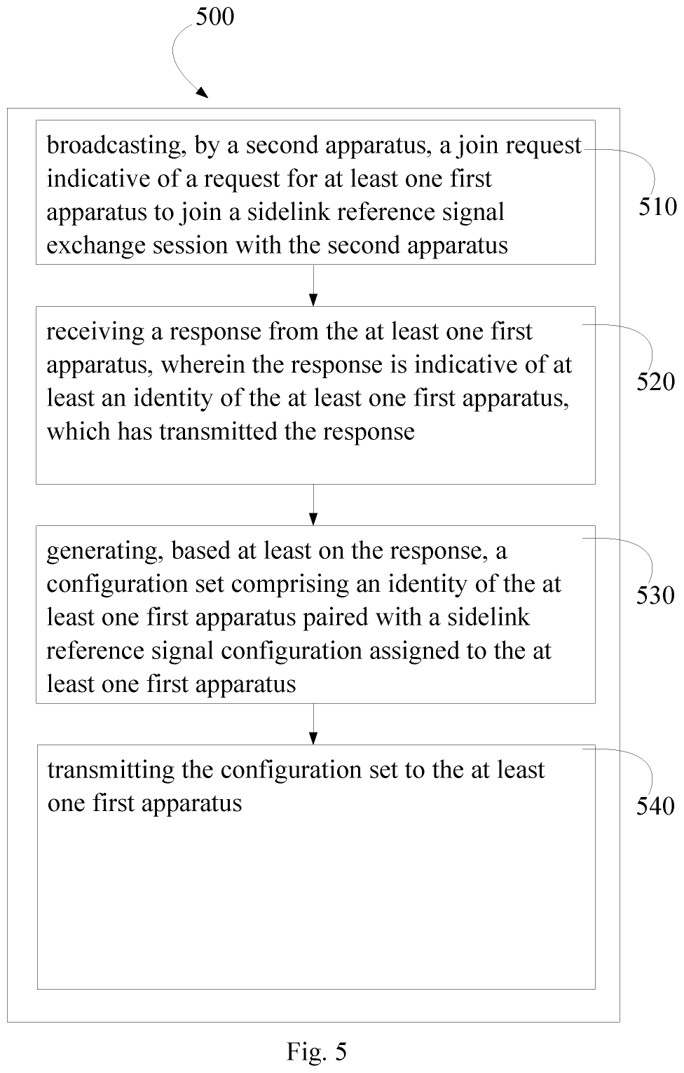

FIG. 5 shows, by way of example, a flowchart of a method 500. The method may be performed by an apparatus, e.g. a second apparatus, which may be a target UE. The method 500 comprises broadcasting 510, by a second apparatus, a join request indicative of a request for at least one first apparatus to join a sidelink reference signal exchange session with the second apparatus. The method 500 comprises receiving 520 a response from the at least one first apparatus, wherein the response is indicative of at least an identity of the at least one first apparatus, which has transmitted the response. The method 500 comprises generating 530, based at least on the response, a configuration set comprising an identity of the at least one first apparatus paired with a sidelink reference signal configuration assigned to the at least one first apparatus. The method 500 comprises transmitting 540 the configuration set to the at least one first apparatus.

The methods disclosed herein enable detection of conflict and conflict resolution in relation to sidelink reference signal resources and configuration. The methods disclosed herein ensure reliability of the sidelink reference signal exchange sessions, e.g. positioning or ranging, such that possible conflicts do not deteriorate the performance of the session. For example, transmission of the same reference signal, e.g. S-PRS, in the same resources by different anchor UEs is prevented.

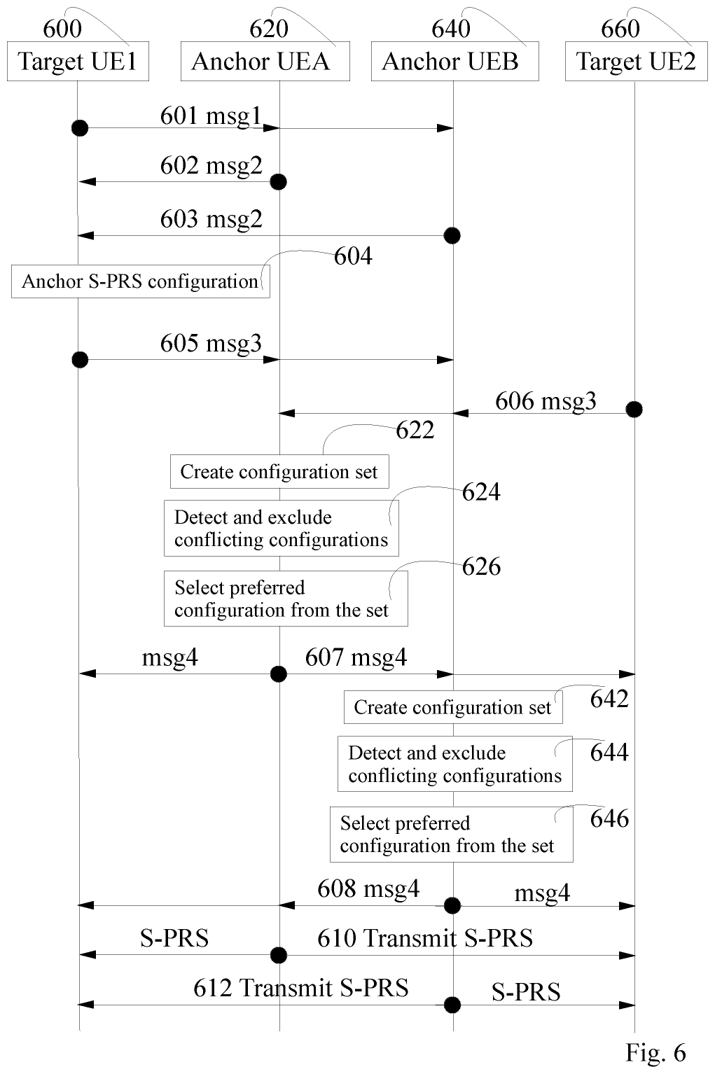

Details of the methods will be described in the context of the signalling diagram of FIG. 6.

FIG. 6 shows, by way of example, signalling between user equipments. Let us consider that the resources used by the UEs 600, 620, 640, 660 are selected based on the sidelink mode 2 resource allocation procedure. This ensures that collisions between transmissions from different UEs are avoided. Let us consider that the UEs 600, 620, 640, 660 follow the same synchronization source, e.g. GNSS or another SyncRef UE.

The sidelink reference signal is a PRS in the example of FIG. 6. However, the same principles apply for other sidelink reference signal exchange sessions and sidelink reference signals.

A first target apparatus or user equipment 600, target UE1, broadcasts 601 a message, or a join request, indicative of a request for one or more anchor apparatuses or user equipments 620, anchor UEA, 640, anchor UEB, to join a sidelink positioning session as anchors. In other words, the target UE 600 asks, using a broadcast message, other nearby UEs to join its positioning session as anchors. The lightweight broadcast message, msg1, may be contained within a medium access control control element (MAC-CE) or a non-encrypted PC5-interface radio resource control information element (PC5-RRC IE) or PC5 signalling protocol stack (PC5-S), for example. The broadcast message may comprise, for example, identity (ID) of the target UE i.e. the sender of the msg1, its positioning latency requirements, accuracy requirements, and a groupcast group ID for reception of the configurations, i.e. to be used later in the process for reception of msg3.

Sidelink UEs which can act as an anchor, e.g. anchor UEA 620 and anchor UEB 640, reply to the request by transmitting 602, 603 a response, msg2. For example, the response may be a short message indicator (SMI) comprising at least an identity of the anchor, i.e. the sender of the msg2. The response msg2 may implicitly indicate that the anchor is joining the positioning session. In addition to the identity of the anchor UE, the response may be indicative of the location of the anchor UE.

After msg1-msg2 exchange is finalized, the target UE 600 knows the identity and possibly the location of the anchors and proceeds to select a S-PRS configuration for the anchors. The target UE 600 may select some of the anchors or all the anchors who responded to the request with msg2 as participants to the positioning session. Selection of the anchors may be performed according to the implementation. As an example, the target UE may select the best K neighbouring anchors, wherein K (number of the anchors to be selected) depends on the localization method. For example, K equals 3 for standard triangulation. The best neighbouring anchors refer to the anchors whose responses, i.e. msg2, are received with the highest power.

The target UE 600 selects 604 or assigns S-PRS configuration for the selected anchors. In other words, the target UE proposes preferred S-PRS configurations for the anchor UE. The configuration corresponds to resource allocation by selecting time-frequency-code resources per anchor. Additionally, space may be selected in the configuration when beamforming or multi-user MIMO is applied. The selection of the time-frequency-code resources may be assumed to follow the sidelink mode 2 resource allocation principles, but applied to the selection of the resources to be used for the transmission of S-PRS by the anchor UEs.

The target UE 600 generates, based at least on the received responses, a set of configurations assigned to different anchor UEs. The set of configurations, e.g. a list of configurations, may be generated as a list of pairs. A pair comprises an anchor ID and S-PRS configuration assigned to the anchor associated with the anchor ID. As an alternative to a list, any suitable data structure may be used, in which an anchor ID is paired with S-PRS configuration assigned to the anchor associated with the anchor ID. The configuration set, or the list, may comprise one or more pairs. The list may comprise anchor IDs paired with S-PRS configuration assigned to the anchor in question. For example, the list of pairs or configurations may comprise:
(anchor UEA, S-PRS configuration A); (anchor UEB, S-PRS configuration b); (anchor UEC, S-PRS configuration C) . . .

A second target UE 660, target UE2, has performed a similar msg1-msg2 exchange as the first target UE 600. The second target UE 660 generates a list of pairs “anchor ID, S-PRS configuration”.

The target UE1 600 transmits 605 the generated list of pairs, msg3, to anchor UEs 620, 640. The target UE2 660 transmits 606 the generated list of pairs, msg3, to anchor UEs 620, 640.

Transmission of the list of pairs, msg3, may be performed by groupcasting using the groupcast group ID. The groupcast group ID may be reflected in the groupcast group ID of the 2^{nd} stage SCI associated with msg3.

Target UE1 600 and target UE2 660 may share their own list(s) of configurations, msg3, with a different groupcast group ID previously shared with the anchor UEs 620, 640 in msg1, i.e. the request to join the positioning session.

The msg3 may be groupcasted to all selected anchors, i.e. the anchors selected into the positioning session. The msg3 may also be groupcasted to unselected anchors. In case some of the anchors who responded with msg2 have not been selected, no configuration is selected for those anchors. Then, a respective entry in the list of pairs may be, for example, (unselected_anchor_ID, N/A). Via such signalling, the unselected anchor is released from the positioning session of the target UE, and the anchor may freely join any other session.

The msg3 may be sent to all nearby anchor UEs to maximize the use of the contents of the msg3 by all nearby anchor UEs. In this case, the message may be sent unencrypted, for example within a MAC CE to enable easier decoding at anchor UEs.

The target UE 600, 660 may transmit, along with the list of pairs or configurations, a configuration for transmission of a reservation message. The reservation message may be transmitted via broadcasting. For example, the msg3 may be indicative of time-frequency-code resources for the anchor UEs 620, 640 to be used for transmission of the reservation message. For example, the anchor UEs 620, 640 may be provided with one or more non-overlapping time slots within which the anchor UEs may transmit reservation messages. This way, a possible half-duplex problem in receiving reservation messages from each other is avoided. In addition, the target UE may configure the anchor UE with a time limit for reserving the configuration for transmission of a reservation message. In case the anchor UE will not reserve the configuration in a given time, the configuration will be automatically released.

The anchor UEA 620 and the anchor UEB 640 receive the msg3, i.e. at least the lists generated by the target UEs, from the target UEs. For example, the anchor UEA 620 receives from a first target UE1 600 among the target UEs, a first list comprising an identity of at least one anchor UE paired with a S-PRS configuration assigned to the at least one anchor UE by the first target UE1. That is, the list comprises “anchor ID, S-PRS configuration” pair(s). In case of an unselected anchor, the list may indicate by an entry “unselected_anchor_ID, N/A” that the unselected anchor is released from the positioning session. For example, the first list comprises at least the identity of the anchor UEA paired with a S-PRS configuration assigned to it.

The anchor UEA receives from a second target UE2 660 among the target UEs, a second list comprising an identity of at least one anchor UE paired with a S-PRS configuration assigned to the at least one anchor UE by the second target UE2. That is, the list comprises “anchor ID, S-PRS configuration” pair(s). In case of an unselected anchor, the list may indicate by an entry “unselected_anchor_ID, N/A” that the unselected anchor is released from the positioning session.

For example, at least one of the first list and the second list comprises at least the identity of the of the anchor UEA paired with a S-PRS configuration assigned to it.

In addition, the anchor UEA 620 may receive lists of pairs from further target UEs in the vicinity.

The anchor UEA 620 compares the received lists to each other to find potential conflicts between S-PRS configurations. The anchor UEA selects, based on the received lists, non-coflicting S-PRS configurations for different positioning sessions with the target UEs.

The anchor UE may create 622 an own set of configurations Sₓ based on the received lists by selecting at least some of the configurations assigned to it, i.e. the configurations paired with its UE ID. For example, the anchor UEA may select all the configurations assigned to it, or create a set of preferred S-PRS configurations S_{A} by selecting a subset of the configurations assigned to it and order them by preference. Preference may depend on what the anchor UE tries to optimize. For example, the anchor UE may prefer PRS with smaller bandwidth, and/or smaller repetition rate, or a PRS with a larger comb to enable interleaving other traffic in the empty subcarriers, etc.

The anchor UEA may compare the received lists and its own set S_{A} and identify or detect possible conflicts with its own set of configurations.

If no conflicts are found based on the comparison of the received lists, the anchor UEA may implement the requirements according to its configurations.

In case conflicts are identified 624 or detected based on the comparison of the received lists, the anchor UEA excludes 624 the conflicting S-PRS configurations from its own set, i.e. the set S_{A}. A conflict is identified if the same resources have been assigned to the anchor UEA by different target UEs or the same resources as assigned to the anchor UEA have been assigned to other anchor UEs by the target UEs.

After identified conflicts have been resolved by excluding the conflicting configurations from the set S_{A}, the anchor UEA may select 626 a preferred non-conflicting S-PRS configuration from the set S_{A} that the anchor UEA intends to use.

The S-PRS configurations in a set S_{A} of the anchor UEA may enable the anchor UEA to serve simultaneously various target UEs. However, at least one of the configurations might not be unique and could have been assigned to and selected by at least one other anchor UE serving a different target UE than the anchor UEA. To prevent this, the anchor UEA selects 626 a preferred non-conflicting S-PRS configuration from the set S_{A} and reserves the configured resources for itself by sending a reservation broadcast message.

The anchor UEA 620 broadcasts 607 the reservation message, msg4, indicative of the selected configurations. For example, the reservation message may comprise one or more pairs “UEA ID, selected S-PRS configuration”. The anchor UE may generate a common reservation message comprising one or more configurations to distinct sessions, or separate reservation messages for each “UE ID-configuration” pair.

When performing the selection 626 of the configurations, the anchor UEA listens for other reservation messages broadcasted by other nearby anchor UEs. If conflicting configurations are detected in the reservation messages, the UEA removes the conflicting configurations from its own list before broadcasting its own reservation message. Thus, selecting non-conflicting S-PRS configurations may further be based on the received reservation message(s).

The anchor UEB 640 detects a reservation message, msg4, broadcasted by the anchor UEA 620. The reservation message is indicative of S-PRS configurations selected by the anchor UEA. The anchor UEB may detect several reservation messages broadcasted by nearby anchor UEs.

The anchor UEB 640 applies also the received reservation broadcast message in selection of the non-conflicting S-PRS configurations, in addition to the received lists received as msg3 from target UEs 600, 660.

For example, the anchor UEB may create 642 its own set of configurations, S_{B}, based on the received lists by selecting at least some of the configurations assigned to it, i.e. the configurations paired with its UE ID. For example, the anchor UEB may select all the configurations assigned to it, or create a set of preferred S-PRS configurations by selecting a subset of the configurations assigned to it and order them by preference. The anchor UEB compares the lists and reservation broadcast messages from other anchor UEs, and identifies possible conflicts with its own set of configurations.

If no conflicts are found based on the comparison of the received lists and the reservation broadcast messages, the anchor UEB may implement the requirements according to its configurations.

In case conflicts are identified 644 based on the comparison of the received lists and the reservation broadcast messages, the anchor UEB excludes 644 the conflicting S-PRS configurations from the set S_{B}. A conflict is identified if the same resources have been assigned to the anchor UEB by different target UEs or the same resources as assigned to the anchor UEB have been assigned to other anchor UEs by the target UEs.

After identified conflicts have been resolved by excluding conflicting configurations from the set S_{B}, the anchor UEB may select 646 a preferred non-conflicting S-PRS configuration from the set S_{B} that the anchor UEB intends to use.

The anchor UEB selects 646 a preferred non-conflicting S-PRS configuration from the set S_{B} and reserves the configured resources for itself by sending 608 a reservation broadcast message, msg4, which is indicative of the selected configuration. For example, the reservation message may comprise one or more pairs “UEB ID, selected S-PRS configuration”.

The anchor UEA 620 may refine its set of configurations based on the reservation broadcast message received from anchor UEB 640. Refinement may comprise excluding conflicting configurations.

The anchor UEA 620 transmits 610 S-PRS to the target UEs 600, 660 according to the selected configurations, i.e. using resources indicated by the selected configurations and with the selected configuration.

The anchor UEB 640 transmits 612 S-PRS to the target UEs 600, 660 according to the selected configurations, i.e. using resources indicated by the selected configurations and with the selected configuration.

The target UEs 600, 660 may detect the reservation messages, msg4, broadcasted by the anchor UEs 620, 640. Then, the target UEs may refrain from assigning resources, which are reserved according to the reservation message, to anchor apparatuses.

In at least some embodiments, the anchor UE may receive a join request from one target UE, e.g. only one target UE. In addition, the anchor UE may detect reservation messages broadcasted by one or more other anchor UEs.

In at least some embodiments, the anchor UE may receive join requests from many target UEs. In addition, the anchor UE may detect reservation messages broadcasted by one or more other anchor UEs.

Thus, the detection of conflicts may be performed by the anchor UE by comparing the own configuration set, i.e. the at least one configuration assigned to the anchor UE to one of the following combinations of configurations:
the first configuration set received from a first target UE and one or more reservation messages received from one or more other anchor UEs. For example, the target UE, which has assigned the configuration to the anchor UE might not have detected a reservation message broadcasted by other anchor UE before assigning the configuration.
the first configuration set received from a first target UE and a second configuration set received from a second target UE;
the first configuration set received from a first target UE and a second configuration set received from a second target UE and one or more reservation messages received from one or more other anchor UEs, and optionally more configuration sets received from further target UEs.

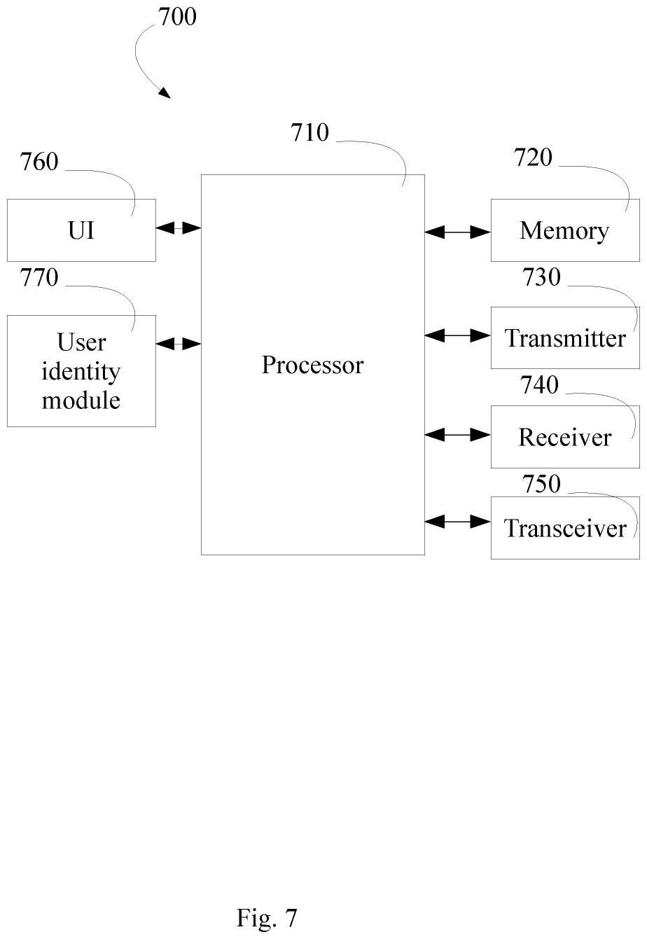

FIG. 7 shows, by way of example, an apparatus capable of performing the methods as disclosed herein. Illustrated is device 700, which may comprise, for example, a mobile communication device such as mobile 600 or 620 of FIG. 6. Comprised in device 700 is processor 710, which may comprise, for example, a single- or multi-core processor wherein a single-core processor comprises one processing core and a multi-core processor comprises more than one processing core. Processor 710 may comprise, in general, a control device. Processor 710 may comprise more than one processor. Processor 710 may be a control device. A processing core may comprise, for example, a Cortex-A8 processing core manufactured by ARM Holdings or a Steamroller processing core designed by Advanced Micro Devices Corporation. Processor 710 may comprise at least one Qualcomm Snapdragon and/or Intel Atom processor. Processor 710 may comprise at least one application-specific integrated circuit, ASIC. Processor 710 may comprise at least one field-programmable gate array, FPGA. Processor 710 may be means for performing method steps in device 700. Processor 710 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 700 may comprise memory 720. Memory 720 may comprise random-access memory and/or permanent memory. Memory 720 may comprise at least one RAM chip. Memory 720 may comprise solid-state, magnetic, optical and/or holographic memory, for example. Memory 720 may be at least in part accessible to processor 710. Memory 720 may be at least in part comprised in processor 710. Memory 720 may be means for storing information. Memory 720 may comprise computer instructions that processor 710 is configured to execute. When computer instructions configured to cause processor 710 to perform certain actions are stored in memory 720, and device 700 overall is configured to run under the direction of processor 710 using computer instructions from memory 720, processor 710 and/or its at least one processing core may be considered to be configured to perform said certain actions. Memory 720 may be at least in part external to device 700 but accessible to device 700.

Device 700 may comprise a transmitter 730. Device 700 may comprise a receiver 740. Transmitter 730 and receiver 740 may be configured to transmit and receive, respectively, information in accordance with at least one cellular or non-cellular standard. Transmitter 730 may comprise more than one transmitter. Receiver 740 may comprise more than one receiver. Transmitter 730 and/or receiver 740 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 700 may comprise a near-field communication, NFC, transceiver 750. NFC transceiver 750 may support at least one NFC technology, such as NFC, Bluetooth, Wibree or similar technologies.

Device 700 may comprise user interface, UI, 780. UI 780 may comprise at least one of a display, a keyboard, a touchscreen, a vibrator arranged to signal to a user by causing device 700 to vibrate, a speaker and a microphone. A user may be able to operate device 700 via UI 760, for example to accept incoming telephone calls, to originate telephone calls or video calls, to browse the Internet, to manage digital files stored in memory 720 or on a cloud accessible via transmitter 730 and receiver 740, or via NFC transceiver 750, and/or to play games.

Device 700 may comprise or be arranged to accept a user identity module 770. User identity module 770 may comprise, for example, a subscriber identity module, SIM, card installable in device 700. A user identity module 770 may comprise information identifying a subscription of a user of device 700. A user identity module 770 may comprise cryptographic information usable to verify the identity of a user of device 700 and/or to facilitate encryption of communicated information and billing of the user of device 700 for communication effected via device 700.

Processor 710 may be furnished with a transmitter arranged to output information from processor 710, via electrical leads internal to device 800, to other devices comprised in device 700. Such a transmitter may comprise a serial bus transmitter arranged to, for example, output information via at least one electrical lead to memory 720 for storage therein. Alternatively to a serial bus, the transmitter may comprise a parallel bus transmitter. Likewise processor 710 may comprise a receiver arranged to receive information in processor 710, via electrical leads internal to device 700, from other devices comprised in device 700. Such a receiver may comprise a serial bus receiver arranged to, for example, receive information via at least one electrical lead from receiver 740 for processing in processor 710. Alternatively to a serial bus, the receiver may comprise a parallel bus receiver.

1. An apparatus which is a first apparatus comprising one or more processors, and one or more memories storing instructions that, when executed by the one or more processors, cause the first apparatus at least to perform:
detecting at least one join request broadcasted by at least one second apparatus, wherein the at least one join request is indicative of a request to join a sidelink reference signal exchange session;
transmitting a response to the at least one second apparatus, wherein the response is indicative at least of an identity of the first apparatus;
receiving, from at least one second apparatus, a first configuration set comprising an identity of at least one first apparatus paired with a sidelink reference signal configuration;
receiving at least one further message indicative of one or more sidelink reference signal configurations; and
based at least on the first configuration set and the at least one further message, selecting at least one non-conflicting sidelink reference signal configuration for the sidelink reference signal exchange session with the at least one second apparatus.

2. The apparatus of claim 1, caused to perform:
detecting at least one further join request broadcasted by at least one another second apparatus, wherein the at least one further join request is indicative of a request to join a sidelink reference signal exchange session;
transmitting a response to the at least one another second apparatus, wherein the response is indicative at least of the identity of the first apparatus; and wherein
the at least one further message is received from the at least one another second apparatus and comprises a second configuration set comprising an identity of at least one first apparatus paired with a sidelink reference signal configuration.

3. The apparatus of claim 1, wherein the at least one further message comprises a reservation message broadcasted by at least one other first apparatus, the reservation message being indicative of one or more sidelink reference signal configurations selected by the at least one other first apparatus.

4. The apparatus of claim 2, caused to perform:
detecting one or more reservation messages broadcasted by at least one other first apparatus, the reservation message being indicative of one or more sidelink reference signal configurations selected by the at least one other first apparatus; and
wherein the selecting at least one non-conflicting sidelink reference signal configuration for the sidelink reference signal exchange session with the at least one second apparatus is further based on the detected one or more reservation messages.

5. The apparatus of claim 1 caused to perform:
broadcasting a reservation message indicative of the selected at least one configuration.

6. The apparatus claim 1 caused to perform:
transmitting a sidelink reference signal to the at least one second apparatus according to the selected configurations.

7. The apparatus of claim 1 wherein the at least one join request broadcasted by the at least one second apparatus comprises one or more of
identity of the second apparatus, which has broadcasted the message;
latency requirements of the second apparatus;
accuracy requirements of the second apparatus;
a groupcast group identity for reception of a configuration set.

8. The apparatus of claim 1 caused to perform:
selecting, at least from the first configuration set, at least one configuration assigned to the first apparatus;
detecting one or more conflicts between the selected at least one configuration assigned to the first apparatus and one or more configurations in the first configuration set and/or the one or more configurations in the at least one further message;
excluding the one or more conflicting configurations from the selected configurations assigned to the first apparatus to obtain at least one non-conflicting sidelink reference signal configuration for the sidelink reference signal exchange session with the at least one second apparatus.

9. The apparatus of claim 1 wherein the sidelink reference signal exchange session is a sidelink positioning or ranging session and the sidelink reference signal is a sidelink positioning reference signal.

10. An apparatus which is a second apparatus comprising one or more processors, and one or more memories storing instructions that, when executed by the one or more processors, cause the second apparatus at least to perform:
broadcasting a join request indicative of a request for at least one first apparatus to join a sidelink reference signal exchange session with the second apparatus;
receiving a response from the at least one first apparatus, wherein the response is indicative of at least an identity of the at least one first apparatus, which has transmitted the response;
generating, based at least on the response, a configuration set comprising an identity of the at least one first apparatus paired with a sidelink reference signal configuration assigned to the at least one first apparatus; and
transmitting the configuration set to the at least one first apparatus.

11. The apparatus of claim 10, caused to perform:
initiating reception of one or more sidelink reference signals from the at least one first apparatus on at least some of resources indicated by the sidelink reference signal configuration associated with the at least one first apparatus.

12. The apparatus of claim 10, caused to perform:
detecting one or more reservation messages broadcasted by at least one first apparatus, the reservation message being indicative of one or more sidelink reference signal configurations selected by the at least one first apparatus;
refraining from assigning resources, which are reserved according to the one or more reservation messages, to first apparatuses.

13. The apparatus of claim 104,
wherein the configuration comprises selecting time-frequency-code resources for the at least one first apparatus.

14. The apparatus of claim 10,
wherein the join request comprises one or more of:
identity of the apparatus;
latency requirements of the apparatus;
accuracy requirements of the apparatus;
a groupcast group identity for reception of a configuration set.

15. The apparatus of claim 10,
wherein the configuration set is transmitted via groupcasting.

16. The apparatus of claim 10, caused to perform:
transmitting, along with the configuration set, configuration for the at least one first apparatus for transmission of a reservation message.

17. The apparatus of claim 16, caused to perform:
transmitting a time limit for the at least one first apparatus for reserving the configuration for transmission of a reservation message.

18. The apparatus of claim 10,
wherein the sidelink reference signal exchange session is a sidelink positioning or ranging session and the sidelink reference signal is a sidelink positioning reference signal.

19. A method comprising:
detecting, by a first apparatus, at least one join request broadcasted by at least one second apparatus, wherein the at least one join request is indicative of a request to join a sidelink reference signal exchange session;
transmitting a response to the at least one second apparatus, wherein the response is indicative at least of an identity of the first apparatus;
receiving, from at least one second apparatus, a first configuration set comprising an identity of at least one first apparatus paired with a sidelink reference signal configuration;
receiving at least one further message indicative of one or more sidelink reference signal configurations; and
based at least on the first configuration set and the at least one further message, selecting at least one non-conflicting sidelink reference signal configuration for the sidelink reference signal exchange session with the at least one second apparatus.

20-43. (canceled)
